(19) United States
(12) Patent Application Publication
(10) Pub. No.: US 2005/0018322 A1
(43) Pub. Date: Jan. 27, 2005

(54) Magnetically actuated fast MEMS mirrors and microscanners

(75) Inventors: Eliezer Ben-Gad, Shilat (IL); Moshe Medina, Haifa (IL); Miriam Hershcovitz, Carmiel (IL); Avigdor Huber, Yehud (IL); Slava Krylov, Holon (IL)

Correspondence Address: DR. MARK FRIEDMAN LTD.;C/o Bill Polkinghorn, Discovery Dispatch, 9003 Florin Way, Upper Marlboro, MD, 20772, US

(73) Assignee: TERRAOP LTD.

(21) Appl. No.: 10/853,097

(22) Filed: May 26, 2004

Related U.S. Application Data
(60) Provisional application No. 60/473,586, filed on May 28, 2003.
(60) Provisional application No. 60/492,041, filed on Aug. 4, 2003.

(51) Int. Cl. G02B 5/02; G02B 13/20; G02B 5/08

(52) U.S. Cl. 359/846

(57) ABSTRACT

Magnetically and electromagnetically driven MEMS devices for reflecting light signals and for switching radio frequency (RF) signals are provided. In a preferred embodiment, a light reflecting device such as a mirror or micro-scanner comprises a plate operative to reflect light and at least two conductive flexural actuators connected to the plate and to a substrate and operative to impart a rotation or tilt motion to the plate under a force arising from the interaction of a current passing through the conductive flexural actuators and a magnetic field parallel to the substrate. An RF switch comprises a substrate and a membrane having a longitudinal dimension and a lateral dimension, the membrane positioned substantially parallel to and attached to the substrate and operative to provide at least two switching positions in response to actuation by a Lorenz force acting on it.

### CROSS REFERENCE TO RELATED APPLICATIONS

The present invention claims priority from U.S. Provisional Patent Applications Nos. 60/473,586 filed 28 May, 2003, and 60/492,041 filed 4 Aug., 2003, the content of which is incorporated herein by reference.

### FIELD OF THE INVENTION

The present invention related to miniaturized magnetically and electro-nagnetically actuated micro-electro-mechanical systems (MEMS) devices. In particular, the present invention refers to optical mirrors, optical scanners and radio-frequency (RF) switches, implemented in silicon using MEMS technologies and actuated by Lorentz forces.

### BACKGROUND OF THE INVENTION

Miniaturized optical mirrors for industrial-scanning purposes, displays, direct writing, optical switching, etc. have been part of the MEMS (particularly Si-based) industry for some time. Specific applications may require mirrors with lateral dimensions of about 1 mm or more. Mirrors for optical applications in MEMS use mostly electrostatic actuation. However, several restrictions prevent the use of electrostatic driving for fast, high power, high-resolution and relatively large MEMS mirrors with large deflection angles. Technical difficulties arise during fabrication of large electrostatic mirrors with large deflection angles, mainly due to the gap that normally exists between the mirror (upper electrode) and the substrate (bottom electrode). Combined with the relatively large size of the mirror, large tilting angles dictate a large gap, which implies very high and sometimes unreasonable driving voltages.

High linearity and precision requirements may also suggest the use of magnetic actuators which are driven by a current having low input impedance, and which have low leakage impedances. Some applications may require very high input optical power on the mirror, which constitutes a challenge because of the resulting thermal effects. An additional challenge is the need for actuation of the mirror in a very fast mode with very high resonance frequency.

Magnetically actuated MEMS micromirrors are known. A recent publication describing such mirrors is a paper by M. Schiffer, V. Laible and E. Obermeier, “Design and fabrication of 2D Lorenz force actuated mirrors” IEEE/LEOS Optical MEMS 2002, Lugano, Switzerland, 20-23 Aug. 2002, Conference Digest, p. 163-164, which is incorporated herein by reference. Most of the prior art magnetically-driven structures comprise a mobile section of a mirror plate with deposited conductors or ferromagnetic materials on the mirror plane. Alternatively, tiny magnets are attached to the mirror plate, providing fields vertical to the mirror plane. Fixed permanent magnets or electromagnetic magnets below the mirror plane may also provide the pull/push magnetic fields vertical to the mirror plane. Designs that provide electromagnetic fields using a coil on the mirror plane generate a very small magnetic field vertical to the coil plane and are not common. Designs with a magnetic field parallel to the conductors' plane are known. To the best of our knowledge, all magnetically actuated mirrors in prior art include conductors placed on the mirror, and no prior art includes conductors restricted only to flexural actuators.

U.S. Pat. No. 6,639,713 to Chiu discloses a magnetically actuated optical switch with a mirror vertical to the conductors' plane, and a magnetic field in the conductors plane. The mirror is attached vertically to a base plate that bends out-of-plane around flexible hinges (thereby making only a translational movement). The structure includes electrical conductors on the base plate, and an actuating magnetic field in same plane. The movement of the plate is an angular movement around one of its axes, driven by a force generated by current in the conductors and the magnetic field. The direction of the movement is determined by the current direction. This design is disadvantageous in that the base plate has combined translational and rotary movements, with no point of pure rotational movement. This allows an attached mirror plate (vertically to the base plate and to the hinges of the virtual rotation axis) to perform an in-plane movement, but is not satisfactory for a mirror intended to perform only angular out-of-plane movement (such as scanning) around its centroid. This design is further disadvantageous in that it has a very long electrical conductor line passing through two narrow hinges. The current transfer and heat transfer in the device are therefore limited, thereby causing limited force/moment generation.

U.S. patent application No. 2002/0050744 by Bernstein discloses MEMS mirrors and mirror arrays formed in gimbal-based structures. A magnetic field in the mirror plane causes two different angular movements in the structure of the gimbal. Each gimbal has sections with electrical conductor foils. The direction of movement is determined by the current direction in these conductor foils. Gimbal type structures such as those in Bernstein's disclosure have very long electrical conductor lines passing through two narrow torsional hinges. The current transfer and heat transfer in the device are therefore limited, causing limited (small) force and moment generation.

The main disadvantage of existing designs of the type described above is related to the necessity to locate the conductive coils on the mirror. The actuating moment produced by the electromagnetic (Lorentz) force is proportional to the product of the electric current in the coil, the induction and the area within the coil. Since the maximal current is limited due to the heating of the wires, large coil areas need to be provided. In most cases, the necessity to provide multiple coils results in complicated design and fabrication processes, extensive heating of the mirror and difficulty to provide required optical quality of the mirror surface. Moreover, the width of torsion springs used for the mirror suspension in gimbals need to be as small as possible, and does not provide the area necessary for the deposition of the wire that connects to the coils located on the mirror.

There is therefore a widely recognized need for, and it would be highly advantageous to have magnetically-driven MEMS devices, particularly optical devices such as mirrors and mirror arrays, which are not based on gimbal structures, and which employ flexible actuators capable of imparting high speed, large movements under high current signals.

### SUMMARY OF THE INVENTION

The present invention is of magnetically and /or electro-magnetically driven MEMS devices, in particular mirrors, micro-scanners and RF switches. These forces arise as a result of interaction between the electric current in wires located on the conductive flexural actuators supporting the mirror and an external magnetic field produced by permanent magnets or electro magnets located in the vicinity of the device. In the context of the present invention, “magnetic field” includes both a field generated by a permanent magnet and a field generated by electromagnets. The detailed description disclosure focuses on mirrors, with the understanding that the inventive features detailed with respect to the mirrors are equally applicable to other devices such as RF switches.

The invention discloses magnetically driven MEMS, one-directional (one angular degree of freedom or DOF) and bidirectional (two angular DOFs) micro-scanners, designed for the purpose of fast scanning (low switching time) with high precision and with very high optical input power on their mirrors. Both regular mirrors and micro-scanners utilize high mechanical forces, have low operating power dissipation (hundreds of milliamperes) and include dielectric reflective coatings, which are very low absorption reflective layers having thicknesses on the order of a fraction of wavelength. In contrast with prior art mirrors and micro-scanners, the actuation in the devices of the present invention imparts a non-torsional movement to the mirror or micro-scanner. That is, the movement of the mirrors and micro-scanners of the present invention may be considered as a pure rotation or tilt.

According to the present invention there is provided a magnetically driven device for reflecting light signals comprising a plate operative to reflect light and at least two conductive flexural actuators, each actuator connected at a first actuator end to the plate and at a second actuator end to a substrate, each actuator operative to impart a motion to the plate under a force arising from the interaction of a current passing through the actuator and a magnetic field.

According to the present invention there is provided a method for manipulating light comprising the steps of: providing a plate; providing at least two conductive flexural actuators connected at a first actuator end to the plate and at a second actuator end to a substrate, each conductive flexural actuator operative to impart a motion to the plate under a force arising from the interaction of a current passing through the actuator and a magnetic field; and imparting a motion to the plate, whereby light impinging on the plate is reflected at a given angle.

According to the present invention there is provided a MEMS light reflecting device comprising: a substrate having a substrate plane; a reflective plate having a longitudinal dimension and a lateral dimension positioned substantially in the substrate plane and connected to the substrate through a conductive flexural mechanism; and a rotation mechanism operative to induce a rotation of the reflective plate around a virtual axis parallel to the lateral dimension and perpendicular to the conductive flexural mechanism. The rotation mechanism is activated by a Lorenz force arising from the combined application of currents in the conductive flexural mechanism and a magnetic field.

According to the present invention there is provided a MEMS light reflecting device comprising a substrate having a substrate plane that includes a center cavity and a membrane having a longitudinal dimension and a lateral dimension and positioned substantially parallel to the substrate plane and attached to the substrate, the membrane further having a reflective center section positioned substantially to overlap the cavity, wherein the membrane center section is operative to rotate in response to actuation around an axis parallel to the substrate plane. The actuation is provided by a Lorenz force arising from the combined application of currents on membrane conductors and a magnetic field.

According to the present invention there is provided a MEMS RF switch comprising a substrate having a substrate plane and a membrane having a longitudinal dimension and a lateral dimension, positioned substantially parallel to the substrate plane and attached to the substrate, the membrane operative to provide at least two switching positions in response to actuation by a Lorenz force.

### BRIEF DESCRIPTION OF THE DRAWINGS

Reference will be made in detail to preferred embodiments of the invention, examples of which may be illustrated in the accompanying figures. The figures are intended to be illustrative, not limiting. Although the invention is generally described in the context of these preferred embodiments, it should be understood that it is not intended to limit the spirit and scope of the invention to these particular embodiments. The structure, operation, and advantages of the present preferred embodiment of the invention will become further apparent upon consideration of the following description, taken in conjunction with the accompanying figures, wherein:

FIG. 1 shows schematically a preferred embodiment of a 1-DOF mirror structure according to the present invention: a) isomeric view; b) side view; c) top view of moving parts;

FIG. 2 shows an alternative embodiment of the 1 DOF mirror structure of FIG. 1, in which the actuator beam springs are each curved in the actuator and in the mirror plane.

FIG. 3 shows an embodiment of a 2 DOF mirror structure with a triple actuator: a) top view; b) isomeric view;

FIG. 4 shows an embodiment of a 2 DOF mirror structure integrated with a linear quadratic actuator: a) top view; b) isomeric view;

FIG. 5 shows an embodiment a 2 DOF mirror structure with a linear quadratic actuator in which the mirror is attached hybridly to the actuator: a) top view of actuator and support structure; b) top view of assembled hybrid structure;

FIG. 6 shows an embodiment of a 2 DOF mirror structure with a square quadratic actuator: top view of integrated structure; b) isomeric view of actuator and support for the hybrid structure;

FIG. 7 shows an embodiment of a 1 DOF virtual axis mirror structure according to the present invention: a) top view; b) isomeric view; c) cross sectional view showing the mirror movement;

FIG. 8 shows a preferred embodiment of a magnetically actuated RF switch according to the present invention;

FIG. 9 shows yet another embodiment of a magnetically actuated mirror according to the present invention;

FIG. 10 shows an exemplary process for fabricating a scanning mirror according to the present invitation.

### DETAILED DESCRIPTION OF THE PREFERRED EMBODIMENTS

The present invention discloses magnetically electrically driven MEMS “plate type” mirrors and micro-scanners positioned in structures in which the magnetic or electromagnetic field is substantially parallel to the mirror plate. The mirrors may be categorized by symmetry as having either a symmetric or asymmetric design. They may be further. categorized as having, in either symmetry, one, two or three axes of rotation. The mirrors may be further categorized by their angular degrees of freedom as having either one DOF or two DOFs. The mirrors may be further categorized by their actuation mechanism as being driven by a single, double, triple or quadratic conductive flexural actuator (see definition below). A conductive flexural actuator according to the present invention may comprise one or more flexural members or beam springs, strips or leafs. Finally, the mirrors may be categorized by the arrangement of the actuators, which may be linear, triangular or square.

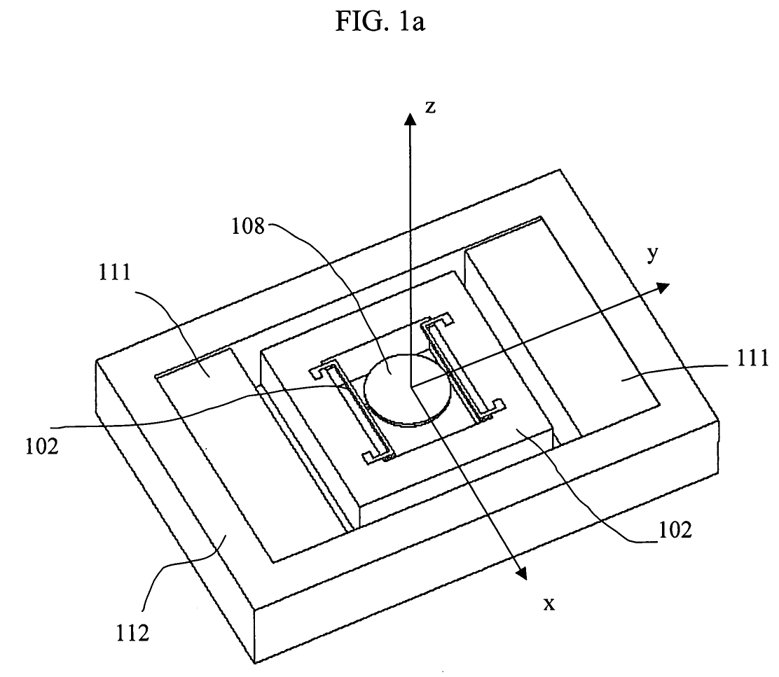

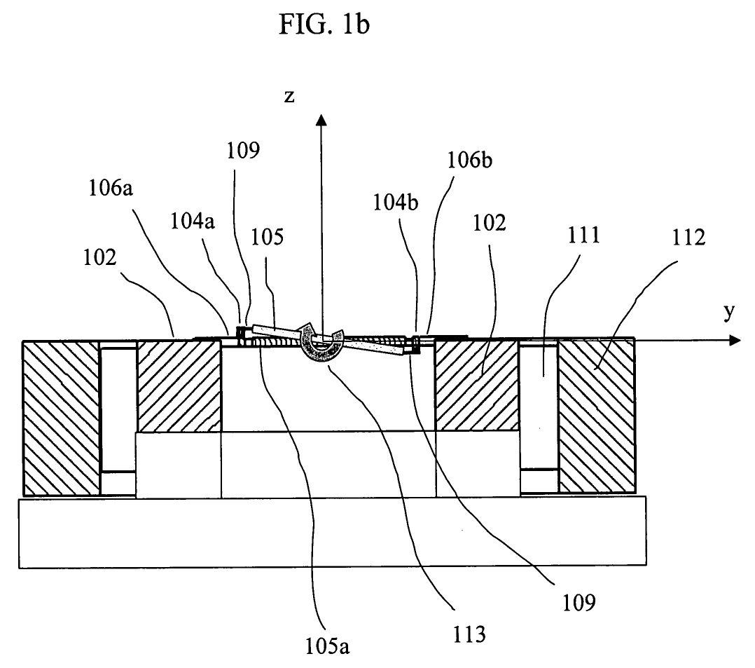

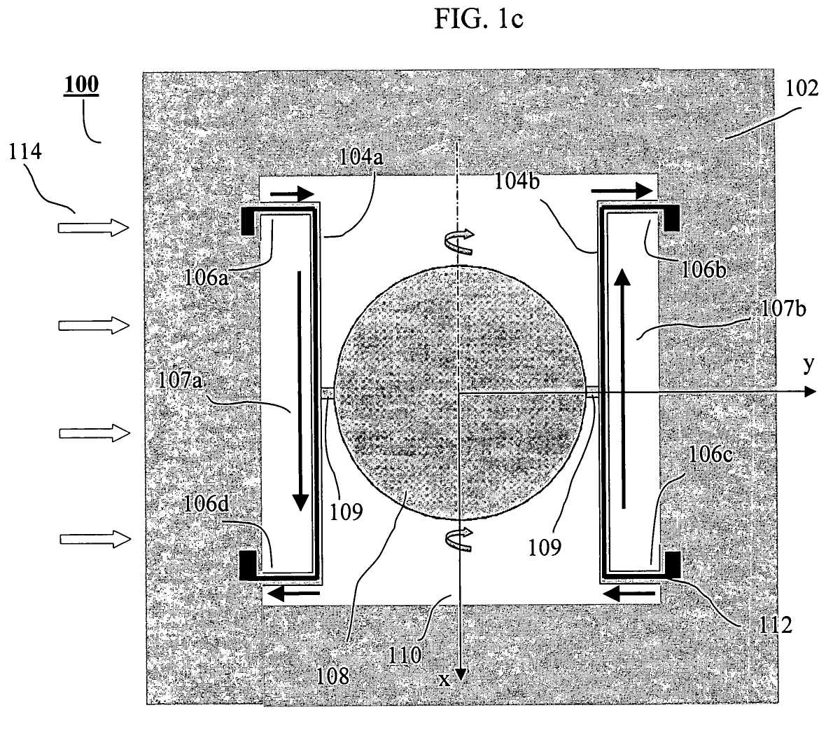

FIG. 1 shows schematically a preferred embodiment of a 1 DOF mirror structure 100 according to the present invention: a) isomeric view; b) side view; c) top view. The structure is shown in an X-Y-Z coordinate system. Structure 100 comprises a substrate 102 to which two flexural actuators (also referred to herein as “conductive flexural actuators”) 104a,b are attached fixedly at end anchors 106a-d. Actuators 104 have an “actuator plane” in the X-Y plane. Structure 100 further comprises a mirror 108 fixedly connected to actuators 104 through small flexures (“hinges”) 109 and operative to rotate around an X-axis 110 under actuation by actuators 104. Mirror 108 is typically in the form of a plate, with pane dimensions in the X-Y plane much larger than a thickness dimension in the Z-direction. The X-Y plane will be henceforth referred to as the “mirror plane” or the “plate plane”. Typical mirror dimensions include a diameter of 4 mm and a thickness of 30 μm. Nevertheless, the structures described herein and the methods for their fabrication may include dimensions that are significantly different from the typical ones mentioned above. Mirror 108 is typically coated with a reflective layer (not shown). Each actuator 104 includes at least one flexible beam spring (referred to simply as “beam”), and is rendered operative to carry an electric current. Typical beam spring dimensions include a length of 10 mm, a width of 15 μm and a thickness of 3 μm. These dimensions, in particular the width, provide the necessary flexibility and a large enough footprint for relatively large conductors, which are essential for the advantageous performance of the mirror. The beams and mirror are preferably fabricated in an active layer of an silicon on insulator (SOI) substrate.

The operativeness of the actuators to carry electrical currents 107a, 107b (FIG. 1c) is rendered for example by electrical conductors 112 in the form of thin or thick metallizations formed with well-known techniques in the art of microelectronics. Alternatively, in the case the beams are made of a semiconductor material such as silicon, the current conduction operativeness may be rendered by conductive layers diffused or implanted into actuator beams 104. We will refer henceforth to all means for rendering flexural actuator beams operative to carry current as “conductors”, and to the actuators themselves as conductive flexural actuators. The conductors make actuator beams 104 responsive to electromagnetic interaction with a magnetic field. Conductors 112 are positioned to carry currents received from an external source through the end anchors: in FIG. 1c, the conductors on actuator beam 104a carry current in the +X direction, and the conductors on actuator 104b carry current in the −X direction. When placed in a magnetic field 114 parallel to the mirror plane (and aligned in FIG. 1c in the Y direction), the Lorenz force arising from the interaction of magnetic field 114 provided by at least one permanent magnet 111 with a ferrous core 116, and the current in each conductor cause actuator 104a to deflect in the +Z direction, and actuator 104b to deflect in the −Z direction. As a result, mirror 108 rotates clockwise as shown around axis 110 [X axis]. Upon reversal of the current direction in the conductors, mirror 108 rotates counterclockwise around axis 110. Typically, mirror 108 may rotate up to ±4.5°. The actuator beams may be optimized in terms of dimensions (cross section, length) to provide a maximum displacement in the Z direction under a given Lorenz driving force and a necessary response time. In contrast with all prior art of magnetically driven actuators, the actuators of the present invention combine electrical conductors with flexible actuating members (beams or springs). The conductors are separate from, and not positioned on, the mirror plate. Preferably, the conductors are located on flexural members between the mirror plate and the anchors of the actuators, thereby providing highly efficiency actuators. The flexural members (beam springs) have a double function: they serve as flexible joints of long deflection and natural frequency adequate for a short response time, and their structure enables high driving currents for high driving forces. These in turn enable the necessary deflections and response time. In contrast, prior art gimbal-type mirrors such as those in U.S. patent application No. 2002/0050744 have conductors on the mirror's plate, formed as one long line of high resistance, which allows only low current and low force. In prior art, the conductors are restricted in width by the narrow torsional hinges of the gimbal. In addition, the hinges are a “wasted” area on which the conductors are not used to exert a driving force. In this invention, the movement of the mirror includes only rotation or tilt. Therefore the “hinges” connecting it to the actuator beams does not have to be narrow, allowing wider conductors.

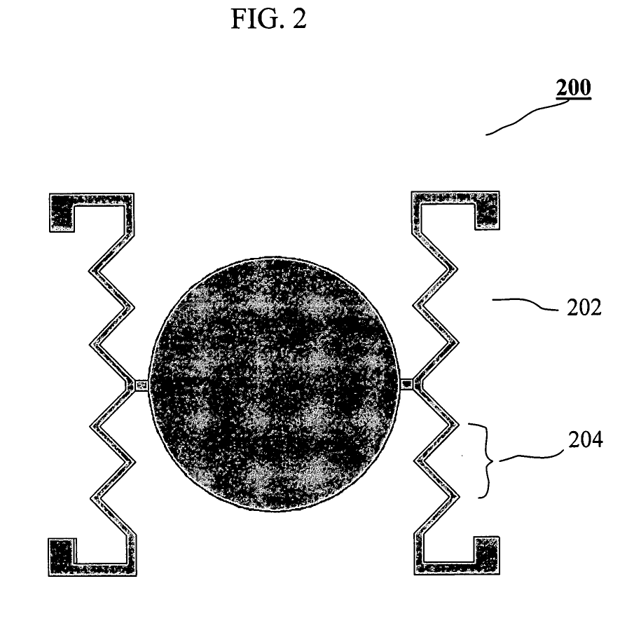

FIG. 2 shows an alternative embodiment of the 1 DOF mirror structure 200 of FIG. 1, in which actuator beam springs 202 are each curved in the actuator plane and in the mirror plane. In contrast with the design in FIG. 1, here each actuator has at least one non-straight line segment along its general length. All shapes that deviate from the simple straight line shown in the embodiment of FIG. 1 are referred to henceforth as a “non-straight segment” shapes. FIG. 2 shows exemplary V-shaped segments 204 that form a “corrugated” actuator. In general, the non-straight segments may have other shapes (e.g. S- or C-shapes) that enhance the beam flexibility and that can yield a higher beam deflection range in a smaller space.

The advantage of a non-straight segment can be explained by the fact that it does not exhibit a stretching force (which is the force acting along the straight beam due to the fact that distance between the ends of the beam is constrained). This increases substantially the beam stiffness, e.g., see J. E. Mehner, L. D. Gabbay and Stephen D. Senturia, Journal of Microelectromechanical Systems, Vol. 9, No. 2, pp. 270-278, June 2000.

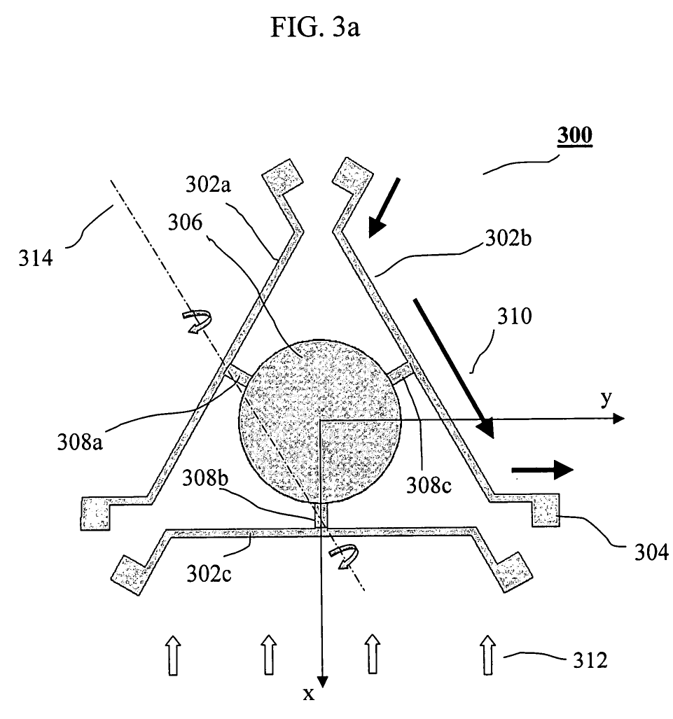

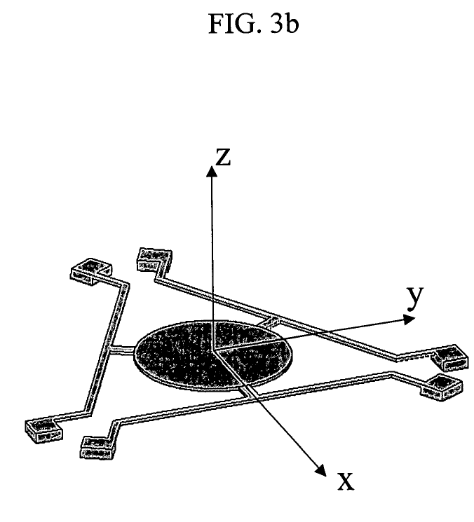

FIG. 3 shows a preferred embodiment of a 2 DOF mirror structure 300 that comprises a triple actuator: a) top view; b) isomeric view. The triple actuator includes three flexible actuator beams 302a,b,c, each attached to a substrate (not shown) by two end anchors 304. Structure 300 further comprises a mirror 306 attached flexibly to each actuator beam by a short flexure 308a-c. As in the previous embodiments, beams 302 are rendered electrically conducting by conductors (not shown). The triple actuator structure provides a second degree of freedom over that in the embodiments of FIGS. 1 and 2. The example below illustrates the operation of this structure:

Assume a current 310 is supplied through beam 302b (FIG. 3a) and assume that a parallel magnetic or electromagnetic field 312, shown in FIG. 3a, acts in the mirror plane in the −X direction. The magnetic field and the current create Lorenz forces on the activated spring beams in out-of-plane directions (+Z or −Z), acting to deflect the actuator beam in one of these directions. In the particular case shown in FIG. 3a, beam 302b deflects in the +Z direction. If beams 302a and 302c do not carry current, their deflection from their original positions in the X-Y plane is much smaller than the deflection of beam 302b, and the mirror rotates counterclockwise around a virtual axis 314 that passes through the pair of flexures 308a and b. Flexures (“hinges”) 308a and b are flexible enough to allow this rotation. Reversing the current direction through beam 302b will reverse the mirror rotation to clockwise. Currents may be applied to any combination of one, two or three actuators, i.e. to actuators 302a, 302b or 302c, actuator pairs 302a+302b, 302a+302c or 302b+302c, all three actuators 302a, b, c simultaneously. Applying a defined amount of current through a combination of actuators will rotate the mirror around each virtual axis passing though a pair of flexures, thus creating a desired angle of the mirror. This principle of actuation utilizes the fact that the plane is uniquely defined by three points and has therefore three degrees of freedom relevant to optical applications: two rotations and an out-of-plane deflection. Note that the displacements of the mirror in the X-Y plane have no influence on the mirror operation

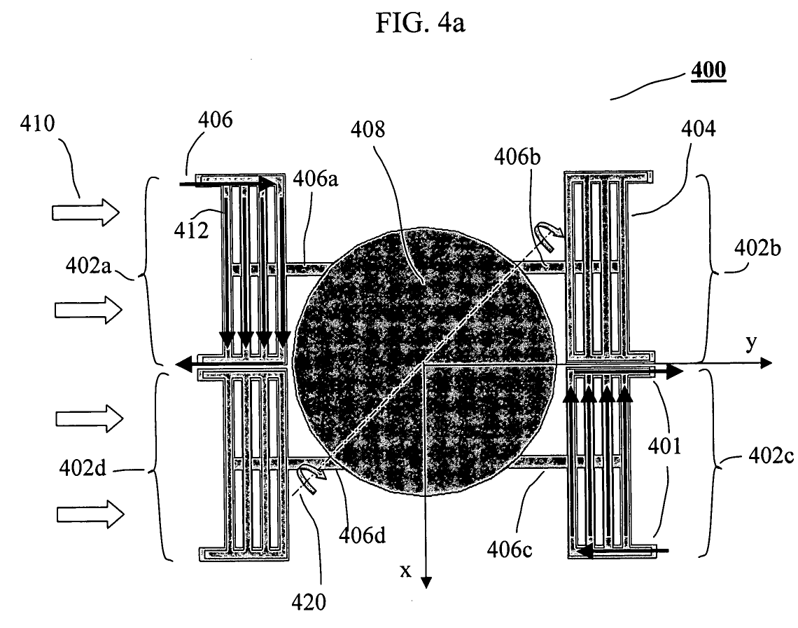

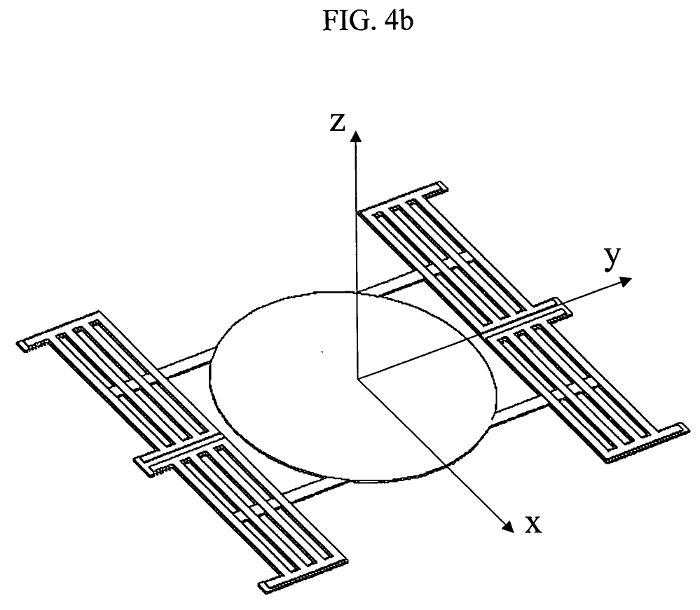

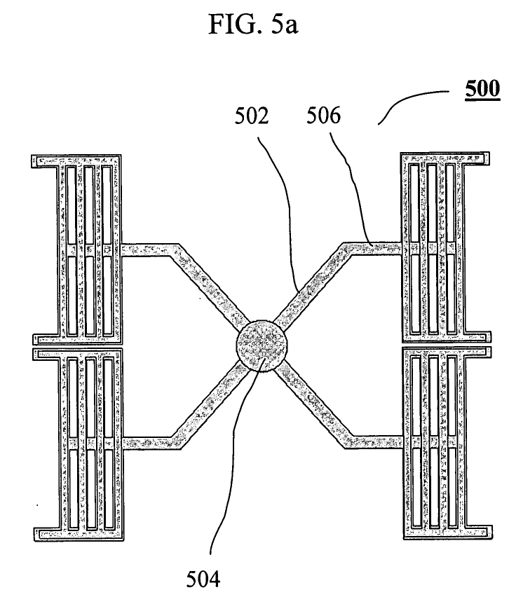

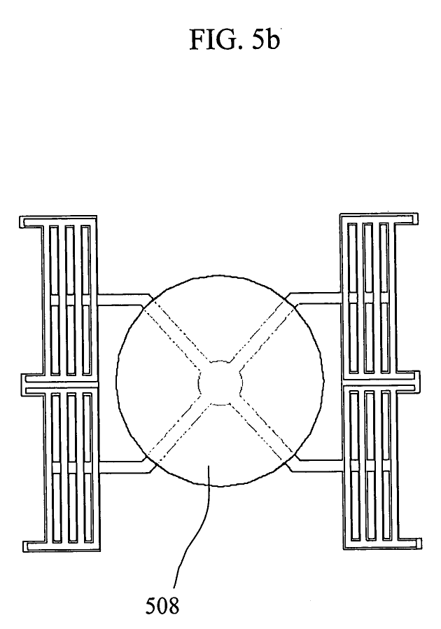

FIG. 4 shows an embodiment of a 2 DOF mirror structure 400 integrated with a linear quadratic actuator: a) top view and b) isomeric view. The quadratic actuator includes four flexural sections 402a-d, each further including a plurality of parallel linear members 404, operative to carry currents. Sections 402a-d are connected through respective end anchors 401 to the substrate, and through respective flexures 406a-d to a mirror 408. In an un-actuated state, sections 402, flexures 406 and mirror 408 all lie essentially in the same X-Y plane. In this embodiment, the mirror may have a typical diameter of 3 mm while the overall area of structure 400 may be typically 10×10 mm. As in the actuation of the previous embodiments, under the combined effect of a parallel magnetic field 410 and a current 412 flowing in members 404, flexural sections 402 move up or down (+Z or −Z direction) causing the mirror to rotate around a virtual axis. The currents may be chosen to pass through different pairs of sections 402. For example, as indicated in FIG. 4a, a current 412a is flowing in the −X direction in members 404 of section 402a, while a current 412c flows in the +X direction in members 404 of section 402c. This combination results in section 402a moving upward (+Z direction) and section 402c moving downward (−Z direction) causing the mirror to rotate around a virtual axis 420 FIG. 5a shows an embodiment a 2 DOF mirror structure 500 with a linear quadratic actuator in which the mirror is attached hybridly to the actuator. The structure is similar to that of FIG. 4, except that the actuating structure includes four beams 502 attached at one end to a preferably circular carrier plate 504 and at another end to flexural sections 506. A mirror fabricated separately from the actuating structure can be attached by any known means (e.g. by gluing) to plate 504. An assembled structure that includes a mirror 508 is shown in FIG. 5b. Advantageously, the hybrid construction enables attachment of different types of mirrors. Since the mirror is attached to the structure in a small area at the structure center, there is minimal sensitivity to distortion of the mirror due to thermal expansion or mechanical stresses.

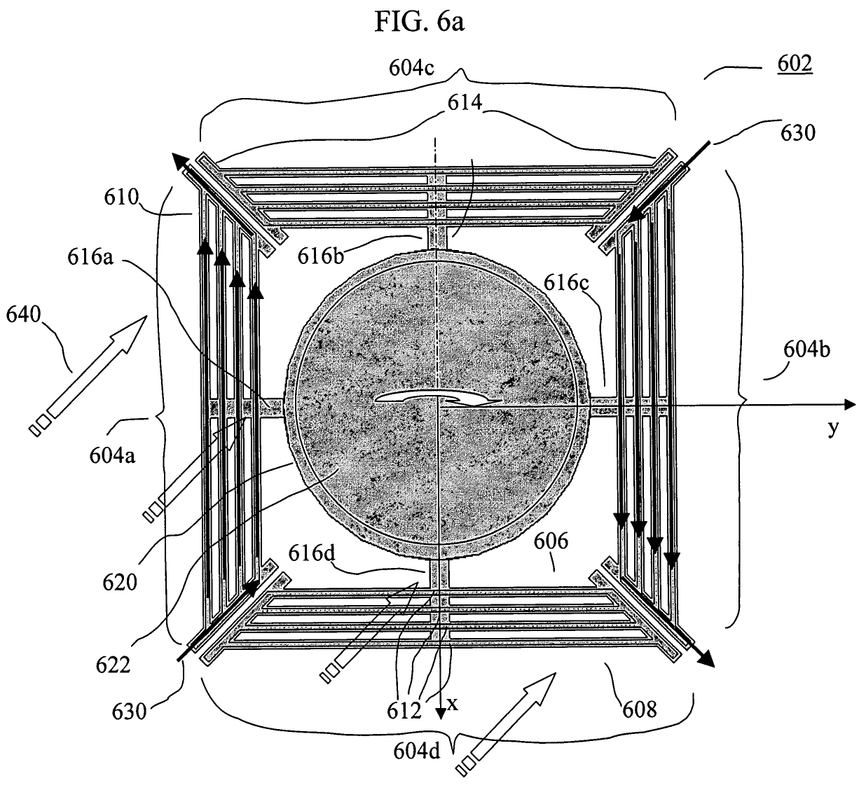

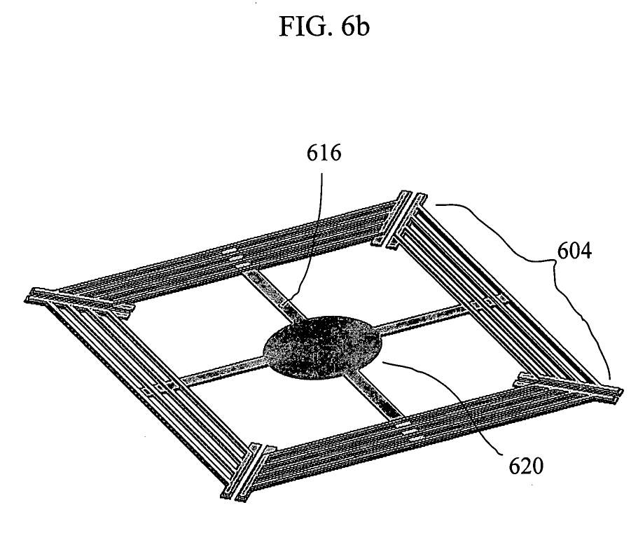

FIG. 6 shows embodiments of a 2 DOF mirror structure with a square quadratic actuator, in both an integrated form and a hybrid form. FIG. 6a shows a square quadratic actuator 602 comprising 4 flexural sections 604a-d. FIG. 6b shows just the actuating and support structure. Each section 604 has a general shape of a trapeze, with an internal (toward the center of the structure) narrower base 606 and an external larger base 608. Each flexural section includes a plurality of linear members 610 operative to carry currents through conductors 612 and disposed in parallel to the bases. Flexural sections 604 are anchored at their trapeze sides by end anchors 614. These anchors might be connected to the substrate at their outer end, or may be fully attached to the substrate. As in the embodiment of FIGS. 4 and 5, members 610 of each section 604 are connected through perpendicular flexures 616 to either a mirror base 620 which is preferably coated with a reflective layer 622 (FIG. 6a) or to a small base plate 622 (FIG. 6b). Thus, in the embodiment of FIG. 6a the mirror may be integrated with the actuating structure as a coating, while in the embodiment of FIG. 6b, the mirror may be a separate plate, and is attached hybridly to the base plate of the actuating substrate.

In operation, when a current 630 is supplied through conductors 612 on “active” actuator sections 604a and 604b as shown, while a magnetic or electromagnetic field 640 acts in the mirror plane in the +Y direction, Lorenz forces are generated in these actuators respectively in the in +Z or −Z direction, causing the actuator sections to deflect. The mirror will rotate through a virtual axis passing through two flexures 616, in this example flexures 616b and 616d. Reversing the currents will reverse the rotation direction. Applying a defined amount of current through a combination of actuators will rotate the mirror around each virtual axis passing though a pair of flexures, thus creating a desired angle of the mirror. The structure in FIG. 6 provides an excellent movement control due to the 4 actuators placed in a bi-symmetric arrangement.

A main inventive feature in all of the embodiments of FIGS. 1 to 6 is the electromagnetic actuator comprised of at least one flexural beam (or multiple beams acting as a group) that is rendered electrically conductive and thus responsive to the effects of a parallel magnetic field. In contrast with prior art, here the flexing member itself is conducting, while the mirror does not carry conductors. The resulting Lorenz force bends the beam(s) when current flows in a direction vertical to the beam's long axis and the magnetic (or electromagnetic) field direction. An element (e.g. a mirror) attached to the beam moves with the beam in the same direction at the attachment point. The embodiments illustrate various possibilities of different DOFs of angular movements of the mirror, different number of parallel beams in the actuators and different geometries (size and rigidity or natural frequency vs. deflection under a specific current and magnetic field).

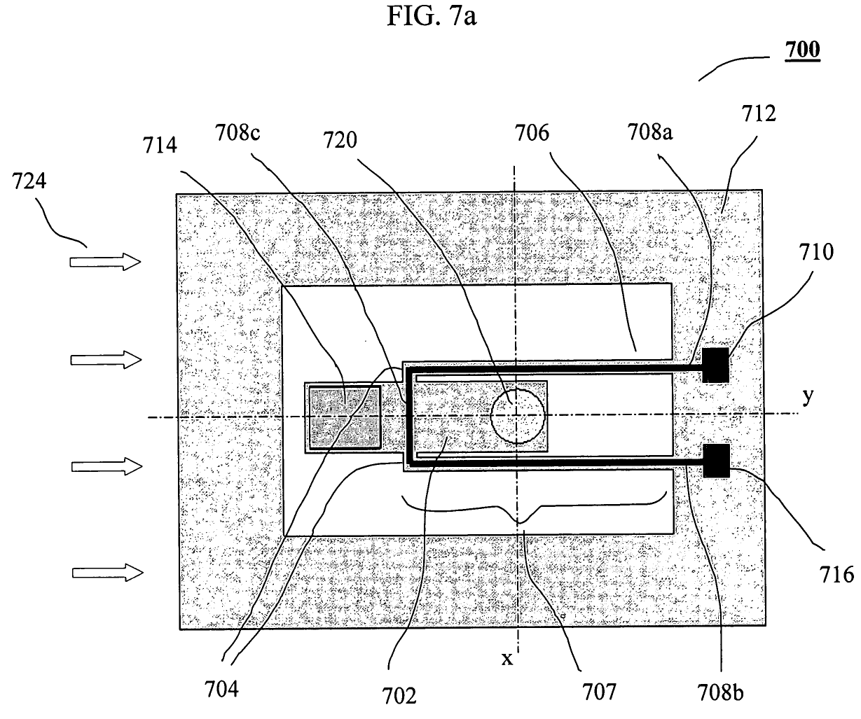

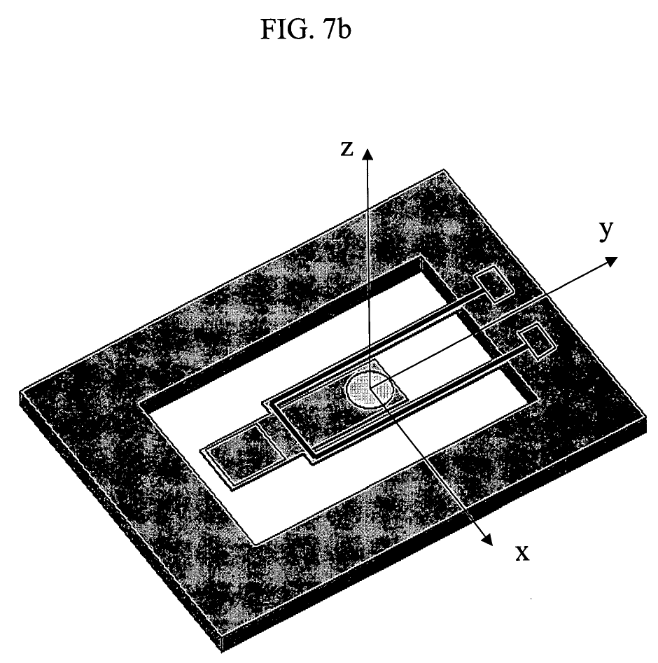

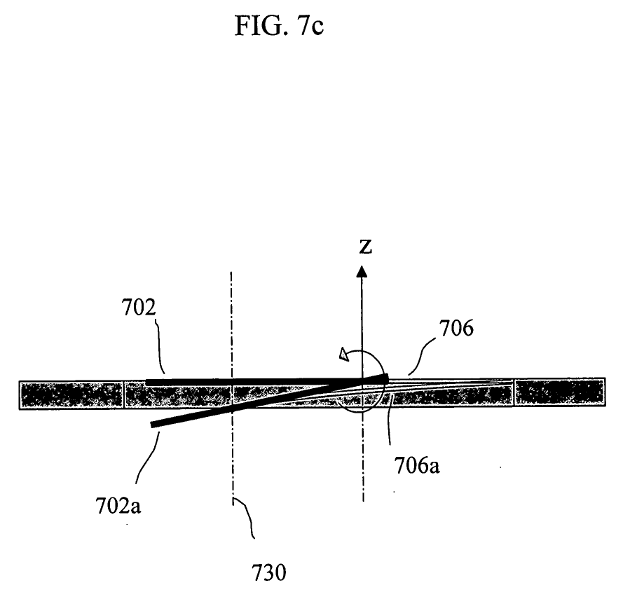

FIG. 7 shows an embodiment of a 1 DOF virtual axis mirror structure 700. The structure comprises a plate 702 connected by two short beams 704 to two longer flexural beams 706. The flexural beams are anchored to a substrate 712, which serves essentially a frame in such a way that they do not touch the substrate anywhere except at the anchors. The plate lies substantially in the same plane as the frame, i.e. the structure is one formed for example by etching a full substrate to form the anchoring frame, beams and plate. Typically, for a mirror of 3 mm diameter on a 20 micron thick plate, spring beam 706 may have a length of about 8 mm and a width of about 200 micron. Beams 706 are rendered operative to carry currents in a similar fashion to that described for the other embodiments above. For example, the beams may be plated with conductors 708a and 708b which are connected through short beams 704 and through plate 702, and have pads 710 and 712 for connectivity to an electrical source (not shown). Structure 700 may further comprise a counter balance plating 714 on plate 702, which may be necessary for the dynamic applications.

A reflective layer or a mirror 720 is placed on the plate 702 at the X,Y axis origin. This location along the Y axis is chosen since that point (assuming the plate 702 is rigid relative to the flexures) has no translation movement but only rotation around the X axis. This feature can be explained in the following way. The (static or dynamic) deflection of the beam is represented in the form:
w(x,t)=Pq(t)φ(x)
where P is the applied force (which can be time dependent), q is a parameter depending on the beam geometry and material properties and φ(x) is a space dependent function. The distance between the location of the virtual axis and the end of the beam x=L

$$e = \frac{w ( L , t )}{{w}^{′} ( L , t )} = \frac{ϕ ( L )}{{ϕ}^{′} ( L )}$$

is independent of the applied force and time and defined only by the function φ. One can conclude therefore that for a beam of specific geometry and boundary conditions, the location of the non-moving point (virtual axis) is constant.

This choice gives the mirror's movement a unique feature of a quasi-gimbal movement, as shown in FIG. 7c. When a current is running for example from an inlet pad 710 through conductors 708a, 708b and 708c to outlet pad 716 and under a magnetic (or electromagnetic) field 724 in the mirror's plane in the +Y direction, a force is generated in conductor 708c which is vertical to the magnetic field, bending flexures 706 in −Z direction. As shown in the cross section along the Y axis in FIG. 7c, flexures 706 are bending to a position 706a (in the −Z direction) and plate 702 is rotating to a position 702a around the X axis in such a manner that the center of the mirror is not deflecting. Line 730 shows the line of descent direction of conductor 708c. The line is parallel to the Z direction.

In summary, the present invention discloses magnetically or electromagnetically actuated fast optical MEMS mirrors and micro-scanners with a number of distinct and advantageous features:
Electrical conductors creating the electromagnetic fields are located on long flexural beams (or strips) that deflect and generate the mirror's rotation. Such an arrangement enables separation between the mirror and the conductors, and keeps the device compact and efficient.
Multiple actuators (2 to 4), each comprised of at least one flexural beam structure, facilitate finer control and efficient use of the electro magnetic fields/forces.
Actuators with short electrical conductor lines enable higher currents and hence higher forces, which are necessary for fast activation and/or high deformations. These short conductor lines further cause smaller line heating and hence lower thermal stresses, lower deformations and smaller heat induced damages. Multiple parallel electrical lines and/or wide lines on the flexural members add the same advantages
The electrical conductor lines are separated from the mirror region, hence heat generated in the lines has low influence on mirror deformation.
The electrical conductor lines and their carrying beams are clamped directly (beam to wall) to the structure supports, hence providing superior conduction heat transfer to the structure base/package. There is no ‘bottleneck’ of electrical lines and heat transfer, as in hinge-type rotation (torsion) axes in prior art.

Finally, in one embodiment of the magnetically actuated fast optical MEMS mirrors and micro-scanners of the present invention, the rotation can be actuated around a virtual axis with no translation of the mirror center (“gimbal-like”), unlike one-sided bending hinges devices in prior art.

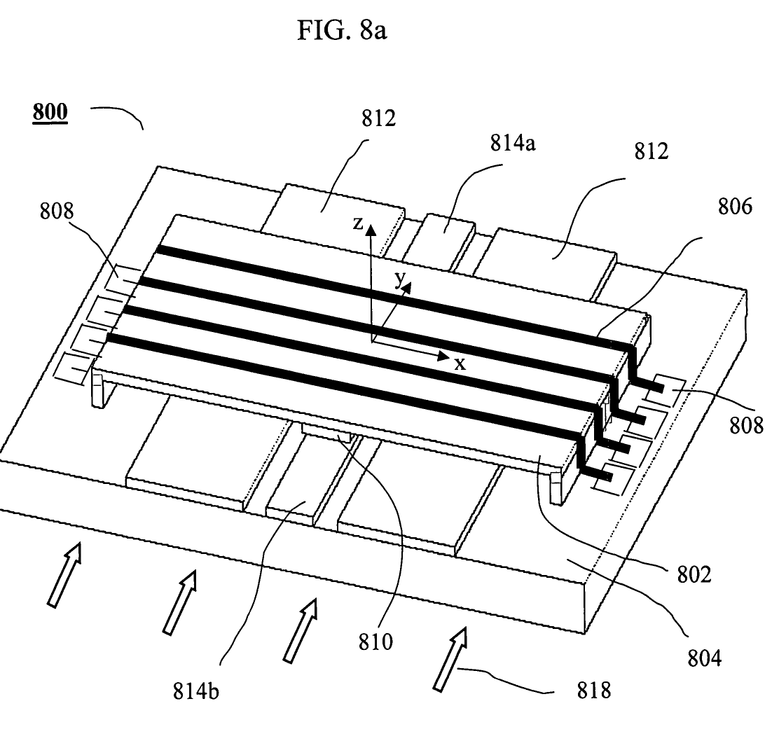

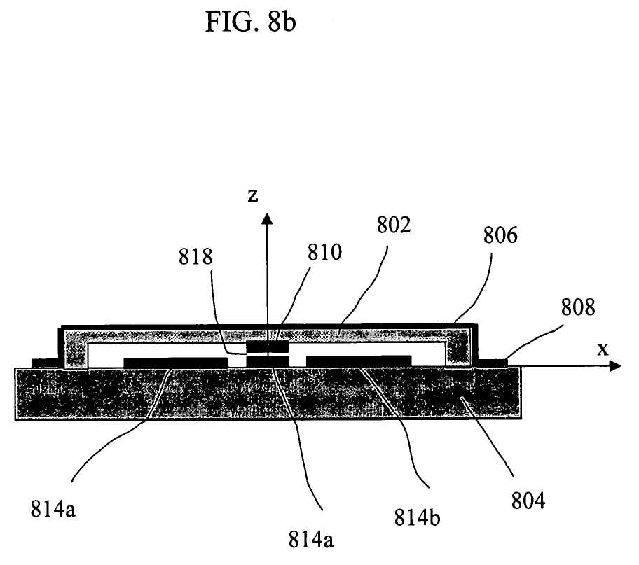

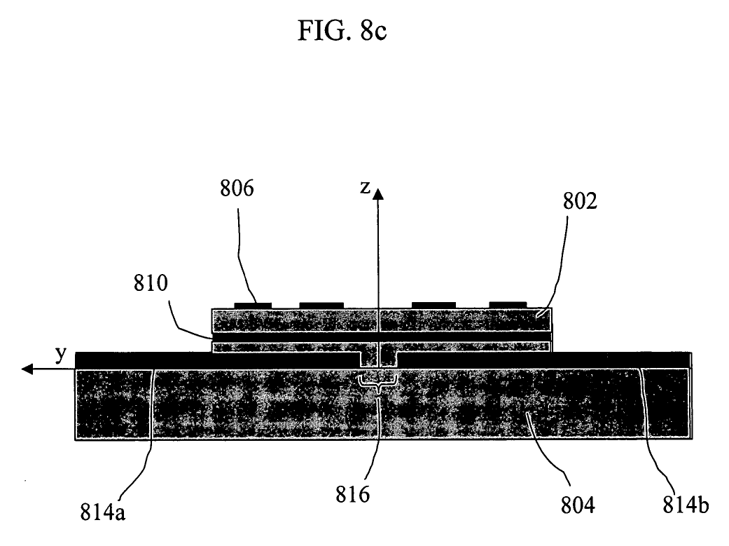

FIG. 8 shows a preferred embodiment of a magnetically actuated fast RF switch 800 according to the present invention. Switch 800 is substantially identical in many of its mechanical elements to a non-magnetically actuated switch disclosed in co-pending U.S. patent application Ser. No. 10/698,462 dated 3 Nov. 2003 by A. Huber et al., which is incorporated herein by reference. Switch 800 comprises a membrane (or beam) 802 attached to a substrate, such as a silicon, SOI or double SOI substrate 804. Membrane 802 has a length dimension in the X direction and a width dimension in the Y direction, as shown. The membrane is plated on a top side (+Z in FIG. 8) along its length with at least one first electrical conductor 806 connected to pads 808 attached to the substrate on both sides of the membrane, as shown. A rectangular, thick conductor segment 810, shown also in FIGS. 8b and 8c, is plated on the bottom side (−Z direction) of the membrane center stretching either the entire width of the membrane, or alternatively part of the width. Two continuous third electrical conductors 812 and a two-segment (814a and 814b) fourth conductor are plated on substrate 804. Segments 814a and 814b are separated by a gap 816 are placed substantially in parallel and in co-linear position and facing conductor segment 810. Conductors 812 are placed in parallel on both sides of segments 814a and 814b. The mutual positioning of segments 810 and 814 is such that in an un-actuated state as in FIG. 8b, there is a small gap 818 therebetween. When a current is applied in conductors 806 in the −X direction and a magnetic (or electromagnetic) field acts in the +Y direction, a Lorenz force is generated in conductors 806, deflecting the membrane in the −Z direction. This leads to a contact being formed between conductor 810 and the two segments of conductor 814 (gap 816 is bridged by conductor 810). Lines 812 in this example are ground lines, and 814a and 814b form the signal line. Typical dimensions of all key elements are similar to those in the co-pending U.S. patent application Ser. No. 10/698,462.

A major advantage of this design for an RF switch lies in having a thin membrane actuator that is extremely fast, since it can have wide conductors that carry high current (and thereby provide a high force) combined with an extremely low mechanical inertia (due to the thin membrane).

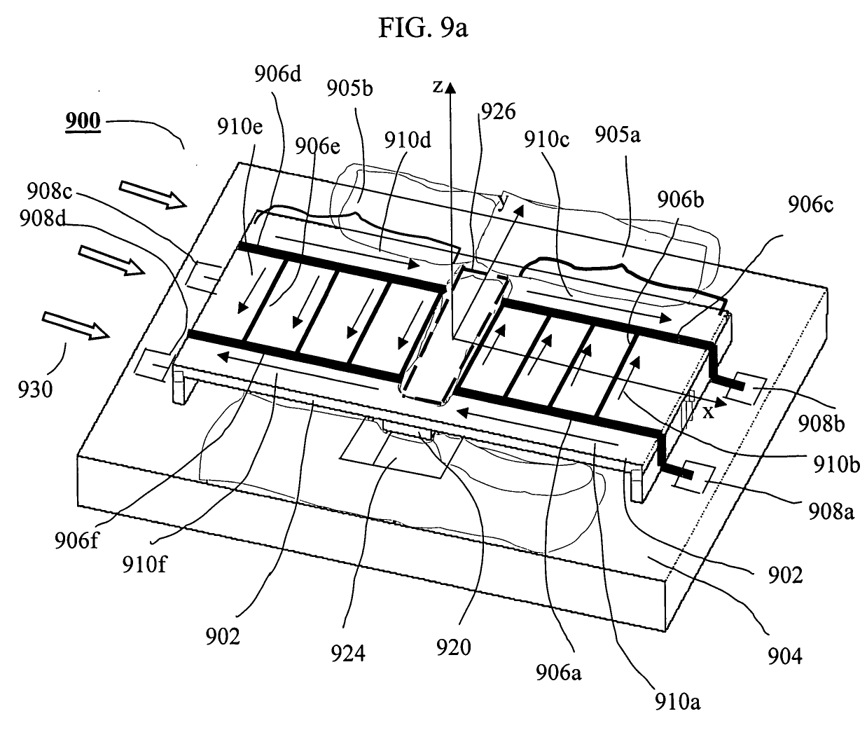

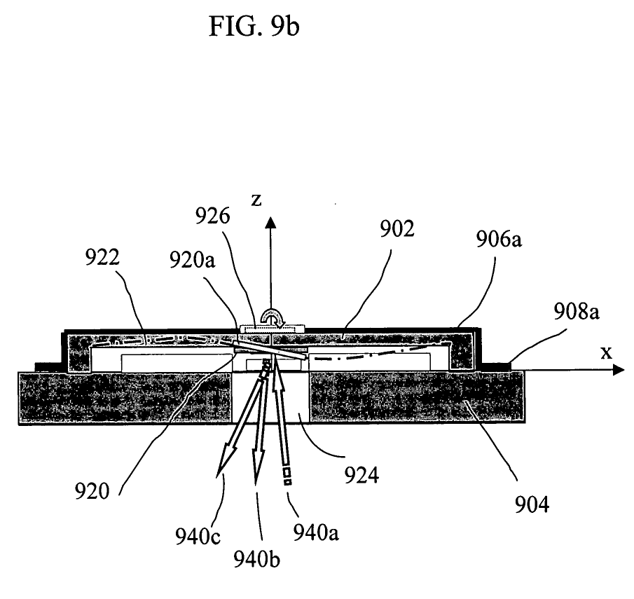

FIG. 9 shows yet another embodiment of a magnetically actuated mirror according to the present invention. The figure shows a mirror device 900 that comprises a membrane 902 operative to rotate around the Y axis. The switch further comprises an area of a reflective layer coated directly on the membrane or on a base plate 920 attached to the membrane at its center (and on the membrane underside, toward a cavity 924, see below). Alternatively, the membrane may have a coated, deposited or attached reflective layer 926 on its top-side (away from center substrate cavity 924), to reflect light coming from above. Membrane 902 is attached to a substrate 904 that has a center cavity 924 at two ends and has two segments or sections (905a and 905b) of electrical conductors plated on it. Each segment has longitudinal (in the X direction) main feeding current conductors and lateral (in the Y direction) “activating” current conductors: section 905a includes longitudinal conductors 906a and 906c and lateral conductors 906b, while section 905b includes longitudinal conductors 906d and 906f and lateral conductors 906e. To perform rotation around the Y axis, a current is applied (FIG. 9a) in each segment 905 and a magnetic (or electromagnetic) field is applied in the membrane plane in the X direction as shown by the arrows. In section 905a a first current is applied from a pad 908a through 906a in a direction 910a through branches 906b in a direction 910b and through 906c in a direction 910c to an output pad 908b. Similarly, in section 905b a second current is applied from a pad 908c through 906d in a direction 910d through branches 906e in a direction 910e and through 906f in a direction 910f to an output pad 908d. A magnetic or electromagnetic field 930 parallel to plane XY is provided in the +X direction. As can be seen in FIG. 9b, the forces developing in each membrane section due to the interaction of currents and the magnetic or electromagnetic field cause the membrane to rotate around the Y axis to a new position line 922 which has a straight segment in the area of the mirror. Thus, mirror 920 rotates to a new position 920a. An input light beam 940a that is reflected back as 940b when the actuators are in a first position, will now be reflected to 940c after the actuators turn the mirror to position 920a.

In summary, in the embodiment of the mirror/micro-scanner shown in FIG. 9, a membrane positioned substantially parallel to the substrate plane has a reflective center section positioned substantially to overlap the substrate cavity, the membrane center section being operative to rotate in response to Lorenz-force actuation around an axis parallel to the substrate plane. In an alternative embodiment, the reflective surface of the center section may point upward, i.e. be on the membrane side opposite to the cavity.

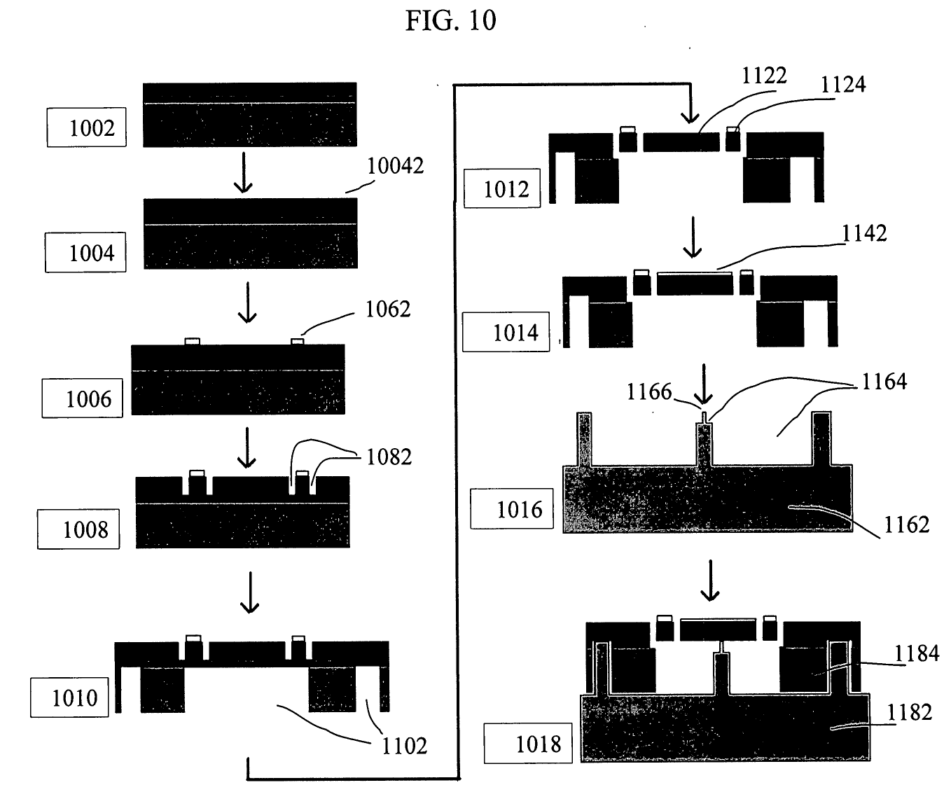

The structures and devices of the present invention are preferably implemented as silicon MEMS structures, using known silicon MEMS technologies and SOI wafers. The flexural members (actuators) and the devices (mirrors or micro-scanners) are preferably formed in the active (top) Si layer of the SOI wafer. Since active layers may have thicknesses ranging from a few micron to a hundred and more microns, the flexural members of the present invention may be formed with any required cross-section, to provide both the width necessary for large conductors, and the necessary flexibility for actuation. MEMS technologies useful in the present invention are described for example in U.S. patent application No. 2003/0001704A1. FIG. 10 shows an exemplary process for fabricating a scanning mirror according to the present invitation. In general a device according to the present invitation may be fabricated using one, two or three wafers. The process described here uses two wafers, a Si wafer and a SOI or double SOI wafer.

The process starts with a SOI wafer in step 1002. A dielectric layer 1042 is deposited on the SOI substrate in step 1004 using any of the well-known deposition techniques. Gold conductors 1062 are produced by depositing Cr/Au (by e.g. evaporation or sputtering) and patterning by photolithography in step 1006. Photolithography followed by deep reactive ion etching (DRIE) is used to open up deep trenches 1082 in the active layer in step 1008. A bottom cavity 1102 is made on the wafer backside to allow free movement of the mirror and to mark the positioning of the second wafer in step 1010. A floating mirror plate 1122 and spring beam (actuator structure) 1124 are fabricated in the active layer in a release step 1012, followed by deposition of a reflective coating 1142 on the mirror in step 1014. A second Si wafer 1162 is patterned and deep etched to form cavities 1164 and standoffs 1166 in step 1016. The two wafers are bonded accurately in step 1018.

In the case of the separate mirror approach (FIGS. 5B and 6B) the mirror is processed separately and attached to the moving structure. The method of attaching the mirror may change in accordance with the material used to implement the mirror. Possible methods of attaching are gluing, soldering, etc.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1. A magnetically driven device for reflecting light signals comprising:
a. a plate operative to reflect light; and
b. at least two conductive flexural actuators, each said actuator connected at a first actuator end to said plate and at a second actuator end to a substrate, each said actuator operative to impart a non-torsional motion to said plate under a force arising from the interaction of a current passing through said conductive flexural actuators and a magnetic field.

2. The device of claim 1, wherein said plate includes a reflective mirror having a mirror plane and selected from the group of an integrated mirror and a hybridly attached mirror.

3. The device of claim 2, wherein said at least two conductive flexural actuators include two parallel straight conductive flexural actuators connected to said mirror on opposite sides, wherein said magnetic field is substantially in said mirror plane, and wherein said current flows in one direction in one of said conductive flexural actuators and in an opposite direction in the other of said conductive flexural actuators, thereby creating two opposite said forces which tilt said mirror around an axis parallel to said conductive flexural actuators.

4. The device of claim 2, wherein said at least two conductive flexural actuators include two parallel corrugated, non-straight segment conductive flexural actuators connected to said mirror on opposite sides, wherein said magnetic field is substantially in said mirror plane, and wherein said current flows in one direction in one of said conductive flexural actuators and in an opposite direction in the other of said conductive flexural actuators, thereby creating two opposite said forces which tilt said mirror around an axis parallel to said conductive flexural actuators.

5. The device of claim 2, wherein said at least two conductive flexural actuators include three conductive flexural actuators arranged substantially in a equi-sided triangle, wherein said magnetic field is perpendicular to said conductive flexural actuators and substantially in said mirror plane, and wherein said current flows in one of said flexures and does not flow in the two other said conductive flexural actuators, whereby said force imparts a tilting motion of said mirror around an axis substantially parallel to said current carrying flexure.

6. The device of claim 2, wherein said at least two conductive flexural actuators include four flexural sections connected in pairs to said mirror on opposite sides, each said section including at least one flexural member, wherein said magnetic field is substantially in said mirror plane, and wherein each said flexural section is operative to carry current in one of two opposite current flow directions.

7. The device of claim 2, wherein said at least two conductive flexural actuators include four trapeze shaped flexural sections arranged symmetrically in said mirror plane, each said section including at least one flexural member, each said trapeze flexural section operative to carry current independently of the other said flexural sections in one of two current flow directions.

8. The device of claim 1, wherein said substrate is selected from the group consisting of a silicon substrate, a silicon-on-insulator (SOI) substrate and a double SOI substrate.

9. The device of claim 1, wherein said magnetic field is generated electro-magnetically.

10. The device of claim 8, implemented as a micro-electro-mechanical system (MEMS) device.

11. A method for manipulating light comprising the steps of:
a. providing a plate operative to reflect light;
b. providing at least two conductive flexural actuators connected at a first actuator end to said plate and at a second actuator end to a substrate, each said conductive flexural actuator operative to impart a motion to said plate under a force arising from the interaction of a current passing through said flexural actuator and a magnetic field; and
c. imparting a motion to said plate, whereby light impinging on said plate is reflected at a given angle.

12. The method of claim 11, wherein said step of providing a plate includes providing a mirror having a mirror plane and selected from the group of an integrated mirror and a mirror attached hybridly to said plate.

13. The method of claim 12, wherein said step of providing at least two conductive flexural actuators includes providing two parallel conductive flexural actuators selected from the group consisting of straight conductive flexural actuators and corrugated, non-straight segment conductive flexural actuators, said actuators connected to said mirror on opposite sides, and wherein said step of imparting a motion to said plate includes:
i. providing said magnetic field to be substantially in said mirror plane, and
ii. providing each said current so that it flows in one direction in one of said conductive flexural actuators and in an opposite direction in the other of said conductive flexural actuators, thereby creating two opposite said forces that tilt said mirror around an axis parallel to said conductive flexural actuators.

14. The method of claim 12, wherein said step of providing at least two conductive flexural actuators includes providing three conductive flexural actuators arranged substantially in a equi-sided triangle, and wherein said step of imparting a motion to said plate includes:
i. providing said magnetic field so that it is perpendicular to said conductive flexural actuators and substantially in said mirror plane, and
ii. flowing said current in only one of said conductive flexural actuators, whereby said force imparts a tilting motion of said mirror around an axis substantially parallel to said current carrying conductive flexural actuator.

15. The method of claim 12, wherein said step of providing at least two conductive flexural actuators includes providing four conductive flexural sections connected in opposite mirror side pairs to said mirror, each said section including at least one flexural member, and wherein said step of imparting a motion to said plate includes:
i. providing said magnetic field so that it is perpendicular to said flexural sections and substantially in said mirror plane, and
ii. flowing currents in a combination of at least two said flexural sections to impart said motion.

16. The method of claim 12, wherein said step of providing at least two conductive flexural actuators includes providing four trapeze shaped conductive flexural sections arranged symmetrically in said mirror plane, each said section including at least one flexural member, each said trapeze flexural section operative to carry current independently of the other said flexural sections in one of two current flow directions.

17. A micro-electro-mechanical system (MEMS) light reflecting device comprising:
a. a substrate having a substrate plane;
b. a reflective plate having a longitudinal dimension and a lateral dimension positioned substantially in said substrate plane and connected to said substrate through a conductive flexural mechanism;
c. a rotation mechanism operative to induce a rotation of said reflective plate around a virtual axis parallel to said lateral dimension and perpendicular to said conductive flexural mechanism.

18. The device of claim 17, wherein said conductive flexural mechanism includes two conductive flexural beams having each two ends and position substantially on opposite sides and in parallel with said plate along said longitudinal dimension, each said beam attached at one said end to said plate and at another said end to a substrate, wherein said beams are connected electrically across said plate.

19. The device of claim 18, wherein said rotation mechanism includes a magnetic field parallel to said substrate plane coupled to a current flowing through said conductive flexural mechanism.

20. The device of claim 19, wherein said magnetic field is selected from the group consisting of a permanent magnet generated magnetic field and an electro-magnetically generated magnetic field.

21. The device of claim 18, wherein said substrate is selected from the group consisting of a silicon substrate, a silicon on insulator (SOI) substrate and a double SOI substrate.

22. A micro-electro-mechanical system (MEMS) light reflecting device comprising:
a. a substrate having a substrate plane that includes a center cavity; and
b. a membrane having a longitudinal dimension and a lateral dimension and positioned substantially parallel to said substrate plane and attached to said substrate, said membrane further having a reflective center section positioned substantially to overlap said cavity, wherein said membrane center section is operative to rotate in response to actuation around an axis parallel to said substrate plane.

23. The device of claim 22, further comprising current carrying electrical conductors disposed on said membrane in a relationship designed to provide actuating forces that provide said rotation upon interaction of said current with a magnetic field substantially parallel to said substrate plane.

24. The device of claim 22, wherein said electrical conductors are divided into two conductor sections, each on a side of said membrane center section so that said conductor sections do not overlap said membrane center section.

25. The device of claim 23, wherein said magnetic field is selected from the group of a permanent magnet generated magnetic field and an electro-magnetically generated magnetic field.

26. The device of claim 22, wherein said substrate is selected from the group consisting of a silicon substrate, a silicon on insulator (SOI) substrate and a double SOI substrate.

27. A micro-electro-mechanical system (MEMS) radio frequency (RF) switch comprising:
a. a substrate having a substrate plane; and
b. a membrane having a longitudinal dimension and a lateral dimension and positioned substantially parallel to said substrate plane and attached to said substrate, said membrane operative to provide at least two switching positions in response to actuation by a Lorenz force.

28. The RF switch of claim 27, wherein said RF switch further includes electrical conductors disposed along said membrane in parallel with said longitudinal dimension and operative to carry electrical currents, whereby said Lorenz force is generated by the interaction of said currents with a magnetic field substantially parallel to said substrate plane.

29. The RF switch of claim 28, further comprising at least one first conductive strip positioned on said membrane facing said substrate, and at least two second conductive strips separated by a gap and positioned on said substrate substantially parallel to said at least one first strips, whereby said at least two switching positions are obtained by said at least one first conductive strip bridging said gap upon said actuation and opening said gap upon a lack of said actuation.
